(19) United States
(12) Patent Application Publication
(10) Pub. No.: US 2026/0080343 A1
(43) Pub. Date: Mar. 19, 2026

(54) ADVANCED SYSTEMS AND METHODS FOR DYNAMIC DIARIZATION-BASED TEAM PERFORMANCE ANALYSIS IN ONLINE MEETINGS

(71) Applicant: Sunshine in Interaction, WIEN (AT)

(72) Inventor: Thomas Spielhofer, Wien (AT)

(21) Appl. No.: 19/370,016

(22) Filed: Oct. 27, 2025

Related U.S. Application Data
(63) Continuation-in-part of application No. 19/211,933, filed on May 19, 2025.
Application No. 19/211,933 is a continuation-in-part of application No. 19/205,445, filed on May 12, 2025.
(60) Provisional application No. 63/645,293, filed on May 10, 2024.
(60) Provisional application No. 63/648,919, filed on May 17, 2024.
(60) Provisional application No. 63/651,707, filed on May 24, 2024.
(60) Provisional application No. 63/651,466, filed on May 24, 2024.
(60) Provisional application No. 63/651,714, filed on May 24, 2024.
(60) Provisional application No. 63/712,195, filed on Oct. 25, 2024.

(51) Int. Cl. G06Q 10/0639

(52) U.S. Cl. CPC G06Q 10/06393

(57) ABSTRACT

A system for dynamically capturing and analyzing communication patterns by dynamically generating and analyzing metadata for online meetings is provided. The system is programmed to: a) receive an audio stream of an online meeting; b) extract a plurality of metadata from the audio stream; c) perform diarization on the audio stream and the plurality of metadata the audio stream to generate diarization information; d) analyze the diarization information to detect communication and team patterns; e) calculate one or more team performance key performance indicators (KPIs) based on the detected communication and team patterns; f) generate recommendations for the team based on the detected communication and team patterns; and g) generate visualization of the one or more team performance KPIs and the recommendations.

### CROSS REFERENCE TO RELATED APPLICATIONS

This application is a continuation in part of U.S. patent application Ser. No. 19/211,933, filed May 19, 2025, which claims priority to U.S. patent application Ser. No. 19/205,445, filed May 12, 2025, which claims priority to U.S. Provisional Patent Application No. 63/645,293, filed May 10, 2024. This application also claims priority to U.S. Provisional Patent Application No. 63/712,195, filed Oct. 25, 2024. The U.S. patent application Ser. No. 19/211,933 also claims priority to U.S. Provisional Patent Application No. 63/648,919, filed May 17, 2024, to U.S. Provisional Patent Application No. 63/651,707, filed May 24, 2024, and to U.S. Provisional Patent Application No. 63/651,466, filed May 24, 2024, and to U.S. Provisional Patent Application No. 63/651,714, filed May 24, 2024, which are hereby incorporated by reference in their entireties.

### BACKGROUND

The field of the invention relates generally to generating and analyzing metadata for online meetings.

As their quality has improved over time online meetings have become increasingly prevalent in various domains, facilitating communication and collaboration among geographically dispersed participants. At the same time online meetings reduce our ability to experience and participate in non-verbal communication, a key component of any human interaction. In modern organizations, employee performance and collaboration are critical to achieving strategic goals. With the rise of remote work, online meetings have become essential for team collaboration and decision-making. However, existing solutions for monitoring team performance during these meetings often lack the necessary precision to assess critical factors such as communication effectiveness, group dynamics, and productivity.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system for capturing and analyzing communication patterns by dynamically generating and analyzing metadata for online meetings is provided. The system includes a computer device includes at least one processor in communication with at least one memory device. The at least one memory device stores computer-implemented instructions that cause the at least one processor to: a) receive an audio stream of an online meeting, wherein the audio stream includes a plurality of participants on a team participating in the online meeting; b) extract a plurality of metadata from the audio stream; c) perform diarization on the audio stream and the plurality of metadata the audio stream to generate diarization information, wherein the diarization information includes information about participation for the plurality of participants on the team in the online meeting; d) analyze the diarization information to detect communication and team patterns; e) calculate one or more team performance key performance indicators (KPIs) based on the detected communication and team patterns; f) generate recommendations for the team based on the detected communication and team patterns; and g) generate visualization of the one or more team performance KPIs and the recommendations. The system may have additional, less, or alternate functionalities, including those discussed elsewhere herein.

In another aspect, a computer device for capturing and analyzing communication patterns by dynamically generating and analyzing metadata for online meetings is provided. The computer device includes at least one processor in communication with at least one memory device. The at least one memory device stores computer-implemented instructions that cause the at least one processor to: a) receive an audio stream of an online meeting, wherein the audio stream includes a plurality of participants on a team participating in the online meeting; b) extract a plurality of metadata from the audio stream; c) perform diarization on the audio stream and the plurality of metadata the audio stream to generate diarization information, wherein the diarization information includes information about participation for the plurality of participants on the team in the online meeting; d) analyze the diarization information to detect communication and team patterns; e) calculate one or more team performance key performance indicators (KPIs) based on the detected communication and team patterns; f) generate recommendations for the team based on the detected communication and team patterns; and g) generate visualization of the one or more team performance KPIs and the recommendations. The computer device may have additional, less, or alternate functionalities, including those discussed elsewhere herein.

In further aspect, a computer-implemented method for capturing and analyzing communication patterns by dynamically generating and analyzing metadata for online meetings is provided. The method is implemented on a computer device including at least one processor in communication with at least one memory device. The computer-implemented method includes: a) receive an audio stream of an online meeting, wherein the audio stream includes a plurality of participants on a team participating in the online meeting; b) extract a plurality of metadata from the audio stream; c) perform diarization on the audio stream and the plurality of metadata the audio stream to generate diarization information, wherein the diarization information includes information about participation for the plurality of participants on the team in the online meeting; d) analyze the diarization information to detect communication and team patterns; e) calculate one or more team performance key performance indicators (KPIs) based on the detected communication and team patterns; f) generate recommendations for the team based on the detected communication and team patterns; and g) generate visualization of the one or more team performance KPIs and the recommendations. The method may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a timing diagram for a process for dynamically generating and analyzing metadata for online meetings in real-time, in accordance with at least one embodiment.

FIG. 2 illustrates a timing diagram for a process for dynamically analyzing online meeting metadata within the context of an online meeting call in real-time, in accordance with at least one embodiment.

FIG. 3A illustrates a flow diagram of a process for diarization in the context of online meeting analysis in real-time, in accordance with at least one embodiment of this disclosure.

FIG. 3B illustrates a graph of diarization as provided by process shown in FIG. 3.

FIG. 4 illustrates the flow of an online meeting being analyzed by the processes shown in FIGS. 1-3A.

FIG. 5 illustrates an exemplary computer system for performing the processes shown in FIGS. 1-3A.

FIG. 6 illustrates an exemplary configuration of a client computer device shown in FIG. 5, in accordance with one embodiment of the present disclosure.

FIG. 7 depicts an exemplary configuration of a server computer device, in accordance with one embodiment of the present disclosure.

FIG. 8 illustrates an example process for calculating Key Performance Indicators (KPIs) based on received diarization.

FIG. 9 illustrates an example process for dynamic diarization-based group performance analysis in online meetings.

FIGS. 10A and 10B illustrate an example process for assessing group interaction dynamics and visualizing conversational gravity within an online meeting environment.

FIG. 11 illustrates an example dashboard 1100 for use with the processes shown in FIGS. 8 and 9, for example.

FIG. 12 illustrates an example dashboard for use with the processes shown in FIGS. 8 and 9, for example.

FIG. 13 illustrates an example dashboard for use with the process shown in FIGS. 10A and 10B, for example.

FIG. 14 illustrates a team performance analysis (TPA) system in accordance with at least one embodiment.

FIG. 15 illustrates a TPA dashboard for the TPA system shown in FIG. 14.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present disclosure introduces a system and method for analyzing online meeting metadata to extract valuable insights regarding group dynamics, group intelligence, meeting effectiveness, productivity, and creativity. The system calculates metrics based on the online meeting metadata metrics. These metrics have been shown to be key meeting success indicators in scientific research in a variety of meeting contexts. By leveraging advanced data processing techniques and machine learning algorithms, the system provides detailed analyses of various aspects of online meetings, including participant speaking patterns, audio characteristics, and group performance metrics. The system thus substitutes the deficiency of online meetings in nonverbal communications with providing context and information by extracting information from the metadata of the meeting that is not available to the participants otherwise.

More specifically, the systems and methods described herein recite a team performance analysis (TPA) system that addresses the need for precision in assessing critical factors such as communication effectiveness, group dynamics, and productivity in monitoring team performance. The TPA system provides data-driven insights into team productivity, creativity, efficiency, and group dynamics. The TPA system offers actionable recommendations to enhance team performance through interventions like team development activities or leadership coaching. The TPA system also empowers organizational leaders and HR experts with the ability to benchmark team performance across departments and monitor it over time.

The TPA system is designed to capture and analyze communication patterns that strongly correlate with team performance. These patterns are identified based on scientific theories, empirical studies, and practical field research. By employing advanced machine learning and diarization techniques, the TPA processes meeting data to extract key insights and generate recommendations to improve collaboration and effectiveness.

The TPA system allows leaders and HR experts to: A) Monitor individual and team performance over time; B) Benchmark performance across teams; and C) Receive data-backed recommendations for leadership coaching and team development. The TPA system supports a team dashboard that displays a plurality of Team KPIs (key performance indicators). In the example embodiment, these KPIs are calculated by a pattern analysis agent described herein. These team KPIs include, but are not limited to, Average Team Productivity, Average Team Creativity, Schedule Discipline, Team Phase, Team Inclusivity, and Key Players. Average Team Productivity is a statistical mean of the meeting productivity KPI across all meetings of the respective team in the defined time span. Average Team Creativity is the statistical mean of the meeting creativity KPI across all meetings of the respective team in the defined time span. Schedule Discipline is the statistical mean of exceeded meeting time across all meetings for the respective team in the given time. Team Phase is the mean variance of changes of centrality per team member over time. This is clustered into two predetermined segments of storming and norming/performing. Team Inclusivity is the reverse variance of the average centrality of team members across all meetings. Key Players include the n team members (n configurable by default to 4) with the highest average centrality across all meetings.

In the example embodiment, the TPA system provides a TPA dashboard. At the end of each meeting, a host general purpose backend stores the entire diarization data at a host datastore. The diarization is the basis for detecting communication patterns.

A TPA team analysis agent retrieves all meetings with the respective meeting attendants from the host datastore. The agent infers the actual (informal) team structures through meeting attendances and stores the team KPIs and their members in the host datastore. In some embodiments, different participants and individuals may be on multiple teams.

The TPA pattern analysis agent retrieves all teams, team KPIs, all meetings per the team, and all meeting KPIs and participants. The TPA agent detects team patterns using unsupervised machine learning and calculates the Team KPIs and team recommendations. The team patterns, team KPIs, and team recommendations and display them at the TPA team dashboard.

The TPA system provides valuable insights on KPIs regarding team performance. This includes productivity, creativity, efficiency, and group dynamics. Furthermore, it gives recommendations on how team performance can be improved by, for instance, means of team developments or leadership coaching. The TPA system enables leaders and HR experts organization-wide to monitor team performance over time, to benchmark team, and how to receive information about team patterns and recommendations how to improve team performance. This improvement of team performance by measuring those communication patterns that strongly correlate with team performance. Correlations, that are strongly founded in scientific theory, empirical evidence, and practical field studies.

The system described herein comprises components for capturing, processing, and analyzing meeting metadata, as well as modules for generating reports, visualizations, and recommendations to aid in data interpretation. Key components include, but are not limited to, a Meeting Metadata Capture Module, a Data Processing and Analysis Module, a Reporting and Visualization Module, and a Recommendations Module.

The Meeting Metadata Capture Module is responsible for collecting data generated during online meetings, including participant speaking patterns, audio characteristics (such as volume, pitch, and rate of speaking), and metadata related to participant location and date/time of participation. However, for privacy reasons, the content of the meeting itself is not captured.

The Data Processing and Analysis Module utilizes machine learning algorithms and statistical techniques. The module processes the captured metadata to extract relevant insights regarding participant behavior, group dynamics, group intelligence, meeting effectiveness, productivity, and creativity. The module employs techniques such as diarization to segment the audio data and identify individual speakers. The module also uses other algorithms to analyze speaking patterns and audio characteristics to assess participant engagement and communication effectiveness. The online meeting metadata metrics being calculated have been shown to be key meeting success indicators in scientific research in a variety of meeting contexts.

The Reporting and Visualization Module generates comprehensive reports and visualizations in real time, or after the meeting, summarizing the findings from the data analysis. These reports provide insights into various aspects of the online meetings, including participant speaking time, contribution levels, group intelligence and other meeting related scores. Visualizations such as graphs and charts are used to present the data in an easily interpretable format.

The Recommendations Module uses metadata of the group interaction to make recommendations to the meeting participants or other third-parties to increase the overall success of the meeting based on scientific findings. This can happen in real time during the meeting and/or after the meeting as a summary report.

As used herein, an Online Meeting is considered a synchronous communication between two or more participants via an audio or video conferencing tool.

As used herein, Meeting Metadata is data that describes data resulting from an audio or video meeting, including participant speaking patterns, audio characteristics, participant location, and date/time of participation. However, metadata does not include the content of the meeting itself.

As used herein, Diarization is a dataset of all occurrences at which a participant spoke during an audio meeting, including length (but not audio volume, pitch, and rate of speaking.)

As used herein, Group Intelligence is the performance or productivity of a team according to a test measuring team performance introduced in scientific research.

As used herein, an Audio or Video Provider is a company or service provider offering software platforms or applications enabling audio or video meetings.

As used herein, a Host UI includes user interface software provided by the party hosting the audio or video meetings.

As used herein, a Provider Specific Backend includes Backend infrastructure specific to a particular audio or video provider.

As used herein, a Host General Purpose Backend includes the Meeting host's software independent of service provider specifics.

As used herein, a Host Datastore is one or more databases where all metadata is stored.

As used herein, a processor ML (Machine Learning) is a computer program able to learn from experience with respect to some class of tasks.

The described system and method offer several advantages over traditional diarization approaches, including: i) Improved accuracy in speaker segmentation by dynamically adjusting segments based on speech activity; ii) Real-time analysis capabilities enable timely insights into participant behavior and meeting dynamics; and iii) Enhanced efficiency through automated segmentation of audio data, reducing the need for manual intervention.

Below are a series of key performance indicator (KPIs) used herein.

AvgDis: the average distance of all participant's turn taking from the average turn taking.

DAP: diarization of all participants.

GII: The intensity of group interaction, calculated by dividing overall turn taking by the elapsed time.

GP: The Conversational Gravity. This is the ratio: centrality of each user/total of all centralities, thus indicating the centrality of a meeting participant relative to the centrality of the other participants.

RST: The relative speaking time for a participant, calculated by building the ratio of his/her relative speaking time and the total speaking time of all participants.

TT: Turn taking, i.e., the number of times each participant spoke in a given time span.

TTT: The total number of turn takings of all participants within a given time span.

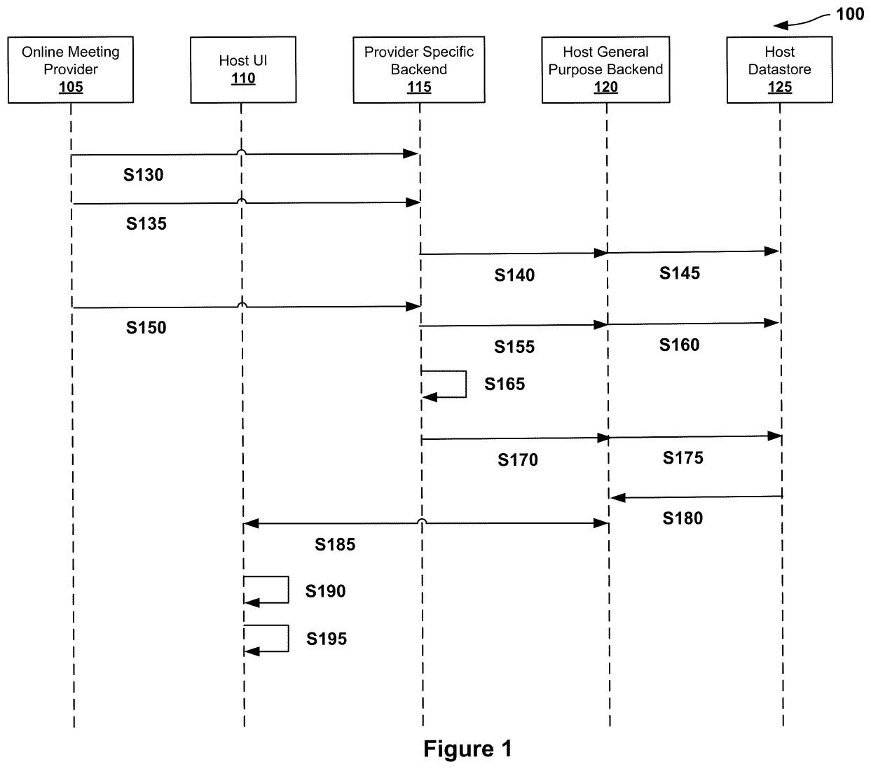

FIG. 1 illustrates a timing diagram for a process 100 for dynamically generating and analyzing metadata for online meetings in real-time, in accordance with at least one embodiment. In the example embodiment, an online meeting provider 105 is in communication with a host system. The host system facilitates the analysis of online meeting metadata by integrating various components to capture, process, and visualize data. The host system may include, but is not limited to, a host UI 110, a provider specific backend 115, a host general purpose backend 120 and at least one host datastore 125. In some embodiments, the host system is associated with one or more of the users attending the online meeting. In other embodiments, the host system is associated with a company or enterprise that is providing the online meeting or has hired the online meeting provider 105.

The online meeting provider 105 is a company or service provider offering software platforms or applications enabling audio and/or video meetings. In many embodiments, the online meeting provider 105 is in communication with a plurality of user device, where the user devices are providing communication with other user devices via the online meeting provider 105. The user devices may include an application that allows them to connect to the online meeting provider 105.

The Host UI 110 includes user interface software provided by the party hosting the audio and/or video meetings. The Provider Specific Backend 115 includes Backend infrastructure specific to a particular audio and/or video provider. The Host General Purpose Backend 120 includes the Meeting host's software independent of service provider specifics. The Host Datastore 125 is one or more databases where all metadata is stored.

In Step S130, the user initiates a call. The process 100 begins when a user initiates S130 an online meeting call through the online meeting provider's platform 105. Upon initiation of the call, the provider-specific backend component 115 extracts S135 the local date and time information of each participant involved in the meeting. In some embodiments, this information is provided by the online meeting provider 105. In Step S135, the Provider-Specific Backend Extracts 115 the Locations of Participants. Simultaneously to step S130, the provider-specific backend 115 extracts S135 the location data of participants, including geographical coordinates or other location identifiers. In Step S140, the Provider-Specific Backend 115 Sends Extracted Metadata to the General Purpose Backend 120. The extracted metadata, including local date and time and participant locations, is sent S140 to the general purpose backend 120 for further processing and then for storage S145 in the datastore 125.

In Step S150, the Online Meeting Provider 105 Continuously Sends Audio Stream data captured during the meeting to the provider specific backend 115 throughout the duration of the meeting. In Step S155, the Provider-Specific Backend 115 Sends Extracted Audio Metadata to the General Purpose Backend 120. The provider-specific backend 115 continuously extracts audio metadata such as pitch, volume, and rate of speaking from the audio stream. This extracted audio metadata is then sent S155 to the general purpose backend 120 for further analysis and to the datastore 125 for storage S160. In Step S165, the Provider-Specific Backend 115 Continuously Calculates Diarization. Diarization is the process of segmenting audio data to identify individual speakers is continuously calculated by the provider-specific backend component 115. In Step S170, the Provider-Specific Backend 115 Sends Calculated Diarization to the General Purpose Backend 120. The calculated diarization information identifies individual speakers and their respective speech segments. In Steps S170 and S175, the calculated diarization is sent to the general purpose backend 120 for subsequent analysis and to the datastore 125 for storage. Steps S150 through S175 continuously repeat as the meeting continues.

In Step S185, the UI 110 Continuously Polls for Diarization from General Purpose Backend 120. The user interface (UI) component 110 continuously polls the general purpose backend 120 to retrieve the latest diarization information stored in the datastore 125. This information may be loaded S180 from the datastore 125 as needed.

In Step S190, the UI 110 Calculates Key Performance Indicators (KPIs) Based on Received Diarization. Upon receiving the diarization data, the UI 110 calculates key performance indicators (KPIs) such as participant speaking time, contribution levels, and other relevant metrics based on the identified speaker segments. Then in Step S195, the UI 110 Visualizes Calculated KPIs and Diarization. The UI component 110 visualizes the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 100 illustrates the systematic flow of operations within the system for analyzing online meeting metadata, from data capture and processing to visualization and analysis.

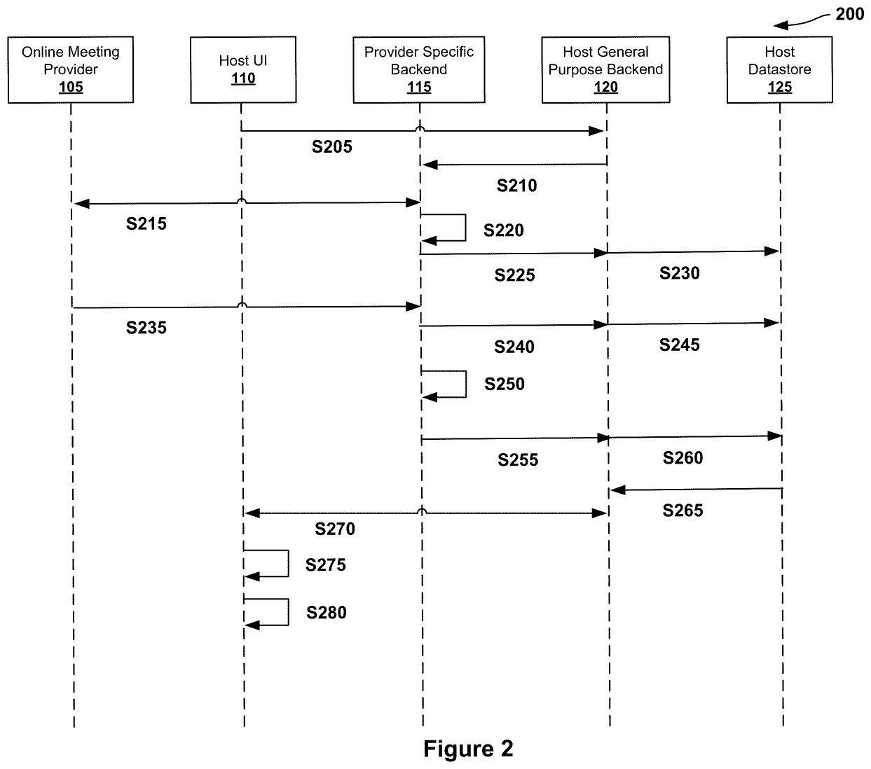

FIG. 2 illustrates a timing diagram for a process 200 for dynamically analyzing online meeting metadata within the context of an online meeting in real-time, in accordance with at least one embodiment. One having skill in the art would have understand that process 200 could be used with online meeting providers 105, such as, but not limited to, Microsoft Teams, Zoom, and Google Meetings.

In Step S205, the user requests bot to join the call. The process 200 begins when a user requests a bot to join the online meeting call, such as within the Microsoft Teams platform. In the example embodiment, the bot is a part of the provider specific backend 115 and the general purpose backend 120. In step S210, the bot joins the call. Upon receiving the user's request, the bot joins the online meeting, enabling its integration into the meeting environment. Then the Backend 115 extracts S215 local date and time of participants. Upon joining the call, the backend component 115 of the MS Teams bot extracts S220 the local date and time information of each participant involved in the meeting. The Backend 115 also extracts S220 location of participants. Simultaneously, the backend 115 extracts S220 the location data of participants, which may include geographical coordinates or other location identifiers.

In step S225, the Backend 115 Sends S225 the extracted metadata to the general purpose backend. The extracted metadata, comprising local date and time and participant locations, is transmitted S225 from the backend 115 to the general purpose backend 120 for further processing and storage S230 in the datastore 125. The online meeting provider 105 Continuously Sends S235 Audio Stream per Participant. Throughout the duration of the meeting, online meeting provider 105 continuously streams S235 audio data from each participant participating in the call. The Backend 115 sends S240 the extracted audio metadata to the general purpose backend 120. The backend 115 continuously extracts audio metadata such as pitch, volume, and rate of speaking from the audio streams of each participant. This extracted audio metadata is then transmitted S240 to the general purpose backend 120 for subsequent analysis and to the datastore 125 for storage S245.

The Backend 115 continuously calculates S250 diarization. Diarization is the process of segmenting audio data to identify individual speakers is continuously calculated S250 by the backend component of the online meeting provider 105. The Backend 115 sends S255 calculated diarization to the general purpose backend 120. The calculated diarization information, which delineates individual speakers and their respective speech segments, is sent from the backend 115 to the general purpose backend 120 for further analysis and to the datastore 125 for storage S260.

In Step S270, the UI 110 Continuously Polls for Diarization from General Purpose Backend 120. The user interface (UI) component 110 continuously polls the general purpose backend 120 to retrieve the latest diarization information stored in the datastore 125. This information may be loaded S265 from the datastore 125 as needed.

The UI 110 Calculates S275 Key Performance Indicators (KPIs) based on received diarization. Upon receiving the diarization data, the UI 110 calculates S275 key performance indicators (KPIs) such as participant speaking time, contribution levels, and other relevant metrics based on the identified speaker segments. Then the UI 110 Visualizes S280 calculated KPIs and diarization. Finally, the UI component 110 visualizes S280 the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 200 illustrates for analyzing online meeting metadata within the context of a Microsoft Teams call, with potential applicability to other online meeting platforms.

As described herein, the processes 100 and 200 for generating and analyzing metadata for online meetings is performed in real-time as the meeting is occurring to allow for real-time analysis of the meeting. This real-time analysis allows for facilitators to make changes in the meeting as the meeting is occurring to ensure that the participants are all able to participate.

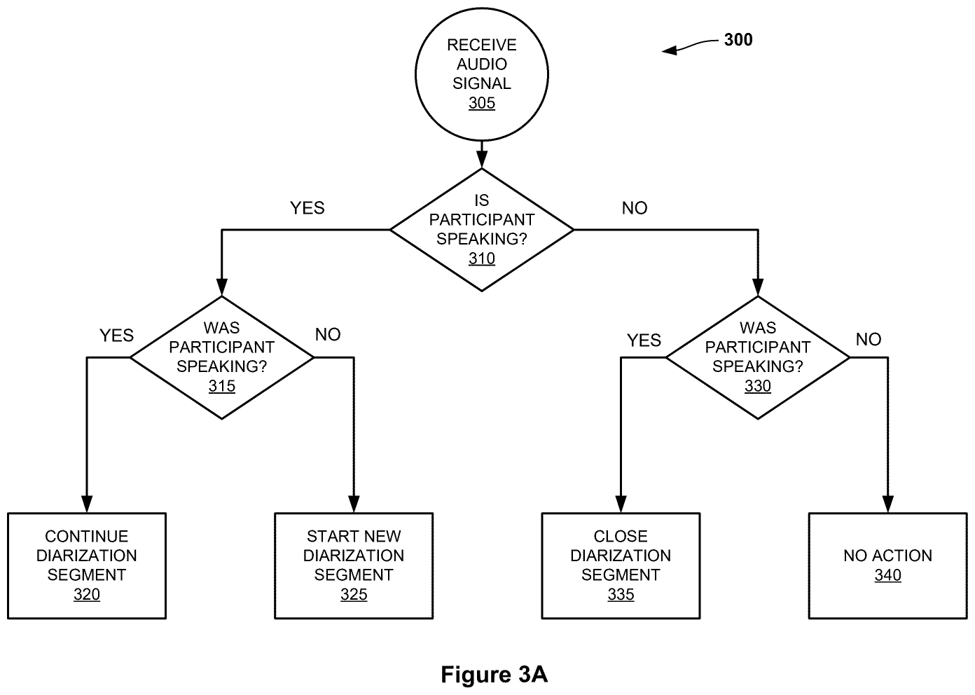

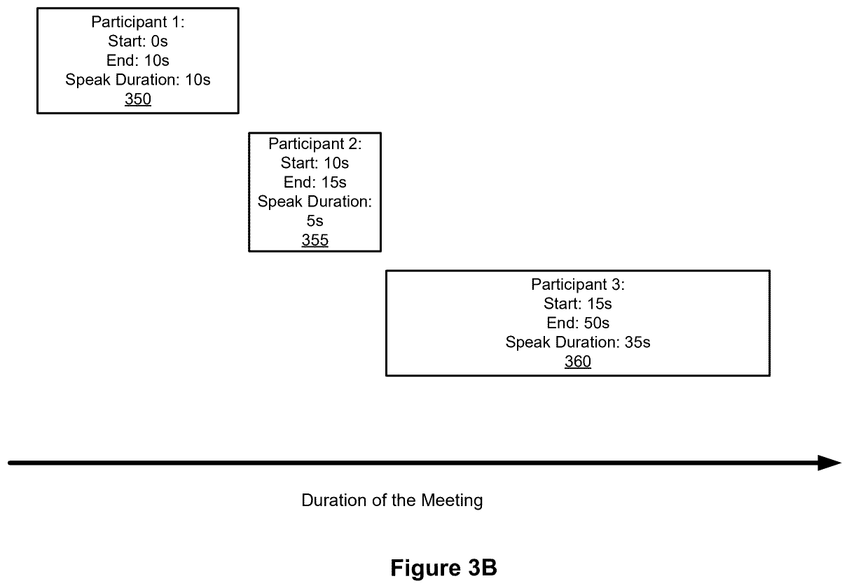

FIG. 3A illustrates a flow diagram of a process 300 for diarization in the context of online meeting analysis in real-time, in accordance with at least one embodiment of this disclosure. For this discussion diarization is the process of segmenting audio data to identify individual speakers and to enable the extraction of valuable insights into participant behavior and meeting dynamics. In the example embodiment, process 300 is performed by the provider specific backend 115 (shown in FIG. 1).

In the example embodiment, the provider specific backend 115 receives 305 the audio signals from online meeting platform 105 (shown in FIG. 1) capturing the speech of participants involved in the meeting. This is similar to step S150 (shown in FIG. 1) and step S235 (shown in FIG. 2). The rest of the steps of process 300 are part of set S165 (shown in FIG. 1) and step S250 (shown in FIG. 2).

The system employs advanced signal processing techniques and machine learning algorithms to determine whether a participant is speaking. This determination is based on factors such as amplitude, frequency, and duration of the audio signal. Upon receiving the audio signal, the provider specific backend 115 employs advanced signal processing techniques and machine learning algorithms to determine 310 whether a participant is speaking. If yes, the provider specific backend 115 checks 315 if participant was speaking before. If yes, the provider specific backend 115 continues 320 the current diarization segment for that participant. If the participant was not speaking, then the provider specific backend 115 starts 325 a new diarization segment for that participant. If the participant is not speaking, the provider specific backend 115 checks 330 if participant was speaking before. If yes, the provider specific backend 115 closes 335 the current diarization segment for that participant. If no one was speaking before, the provider specific backend 115 takes 340 no action.

In the example embodiment, the determination if the Participant is Speaking is done with state of the art “Voice activity detection” mechanisms and programs.

By dynamically adjusting diarization segments based on participant speech activity, the system improves the accuracy and efficiency of online meeting analysis. Additionally, real-time diarization and analysis of meeting metadata enables the system to provide timely insights into participant behavior and meeting dynamics, enhancing the overall effectiveness of the online meeting analysis process.

FIG. 3B illustrates a graph of diarization as provided by process 300 (shown in FIG. 3). The first segment 350 shows that the first participant spoke for 10 seconds. The second segment 355 shows that the second participant spoke for five seconds. And the third segment shows 35 seconds. In some embodiments, there may be blank areas were no participant spoke. In other embodiments, there may be multiple segments for the same participant.

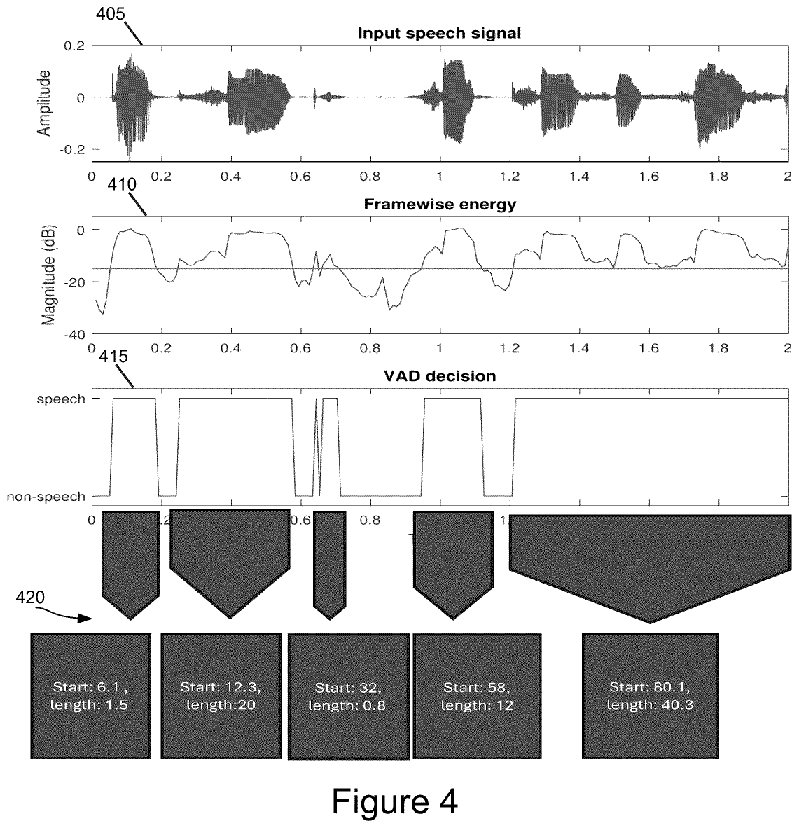

FIG. 4 illustrates the flow of an online meeting being analyzed by the processes 100-300 (shown in FIGS. 1-3A). A first graph 405 illustrates the amplitude of the participant speaking. A second graph 410 illustrates the magnitude of the participant speaking. A third graph 415 illustrates detecting period so speech and no speech. The last section 420 shows the various segments that were determined for diarization.

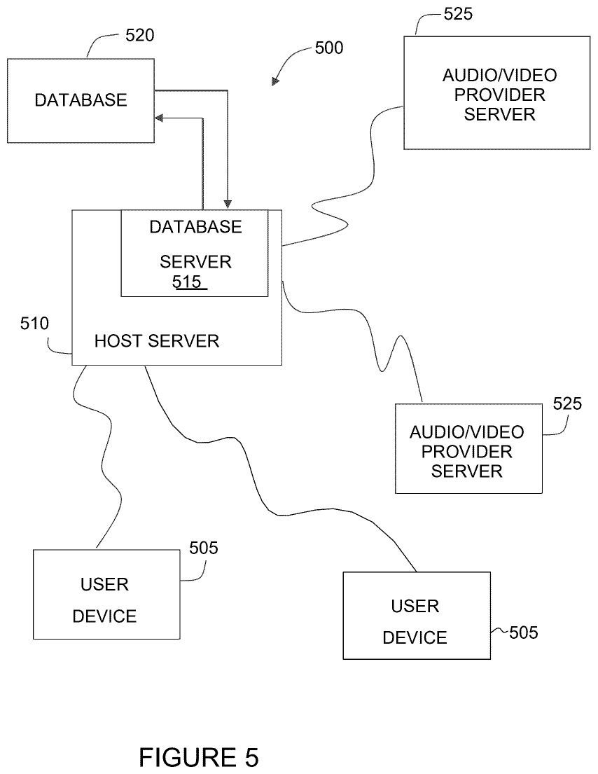

FIG. 5 illustrates an exemplary computer system 500 for performing the processes 100-300 (shown in FIGS. 1-3A). In the exemplary embodiment, the system 500 is used for generating and analyzing metadata for online meetings.

As described below in more detail, the Host server 510 may be programmed for generating and analyzing metadata for online meetings. In some embodiments, the host server 510 may be programmed to: a) receive audio stream of at least one of audio and video of an online meeting, wherein the audio stream includes one or more participants participating in the online meeting; b) extract a plurality of metadata from the audio stream; c) perform diarization on the audio stream and the plurality of metadata the audio stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting.

In the example embodiment, user devices 505 are computers that include a web browser or a software application, which enables user devices 505 to communicate with host server 510 using the Internet, a local area network (LAN), or a wide area network (WAN). In some embodiments, the user devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 505 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the host server 510 is a computer that include a web browser or a software application, which enables host server 510 to communicate with user devices 505 using the Internet, a local area network (LAN), or a wide area network (WAN). Furthermore, the host server 510 may include a host UI 110, a provider specific backend 115, a host general purpose backend 120 and at least one host datastore 125 (all shown in FIG. 1). In some embodiments, the host server 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The host server 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 515 is communicatively coupled to a database 520 that stores data. In one embodiment, the database 520 is a database that includes diarization data and metadata from online meetings. In some embodiments, the database 520 is stored remotely from the host server 510. In some embodiments, the database 520 is decentralized. In the example embodiment, a person can access the database 520 via the user devices 505 by logging onto host server 510. In some embodiments, the database 520 is similar to, or in communication with, the datastore 125.

Audio/Video provider servers 525 may be any third-party server to provide information that host server 510 is in communication with that provides additional functionality and/or information to host server 510. For example, Audio/Video provider servers 525 may be similar to online meeting providers 105 (shown in FIG. 1). In the example embodiment, Audio/Video provider servers 525 are computers that include a web browser or a software application, which enables Audio/Video provider servers 525 to communicate with the host server 510 using the Internet, a local area network (LAN), or a wide area network (WAN).

In some embodiments, the Audio/Video provider servers 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Audio/Video provider servers 525 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

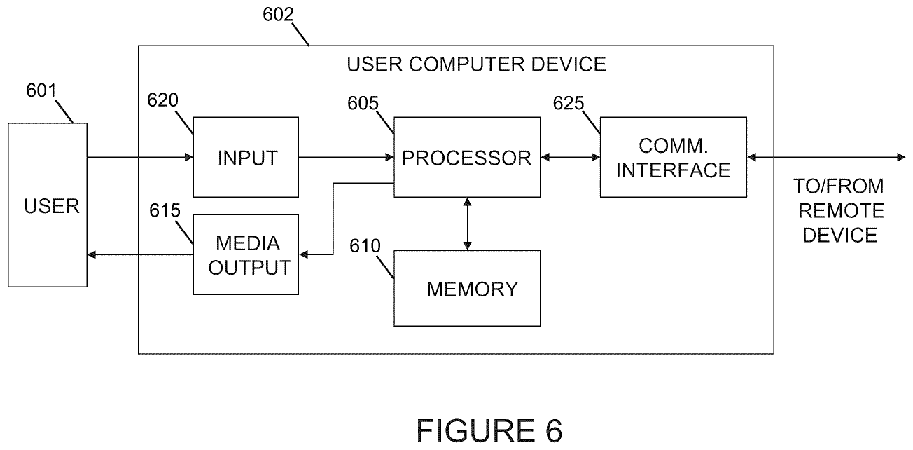

FIG. 6 depicts an exemplary configuration 600 of user computer device 602, in accordance with one embodiment of the present disclosure. In the exemplary embodiment, user computer device 602 may be similar to, or the same as, user device 505 (shown in FIG. 5). User computer device 602 may be operated by a user 601.

User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing items of information provided by the host server 510 (shown in FIG. 5). In some embodiments, user computer device 602 may include an input device 620 for receiving input from user 601. User 601 may use input device 620 to, without limitation, provide information either through speech or typing.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as host server 510. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from Host server 510. A client application may allow user 601 to interact with, for example, Host server 510. For example, instructions may be stored by a cloud service, and the output of the execution of the instructions sent to the media output component 615.

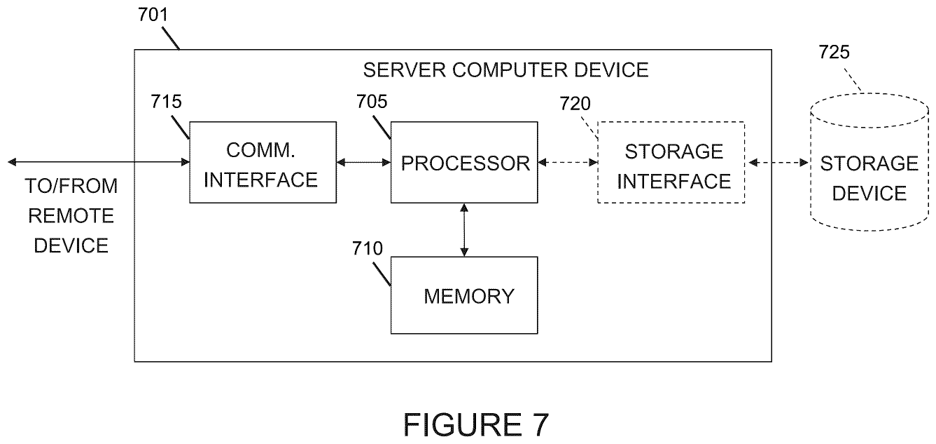

FIG. 7 depicts an exemplary configuration 700 of a server computer device 701, in accordance with one embodiment of the present disclosure. In the exemplary embodiment, server computer device 701 may be similar to, or the same as, online meeting provider 105, host UI 110, a provider specific backend 115, a host general purpose backend 120 (all shown in FIG. 1), host server 510, database server 515, and audio/video provider server 525 (all shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, Host server 510, audio/video provider server 525, and user devices 505 (shown in FIG. 5) (for example, using wireless communication or data transmission over one or more radio links or digital communication channels). For example, communication interface 715 may receive input from user devices 505 via the Internet, as illustrated in FIG. 5.

Processor 705 may also be operatively coupled to a storage device 725. Storage device 725 may be any computer-operated hardware suitable for storing and/or retrieving data, such as, but not limited to, data associated with one or more models. In some embodiments, storage device 725 may be integrated in server computer device 701. For example, server computer device 701 may include one or more hard disk drives as storage device 725.

In other embodiments, storage device 725 may be external to server computer device 701 and may be accessed by a plurality of server computer devices 701. For example, storage device 725 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 725.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 1-3A.

In some embodiments, the host system includes a meeting metadata capture module configured to collect data generated during online meetings, including participant speaking patterns and audio characteristics. The host system also includes a data processing and analysis module configured to process the captured metadata using machine learning algorithms and statistical techniques to extract insights regarding participant behavior and group dynamics and generate meeting success indicators. The host system further includes a reporting and visualization module configured to generate reports and visualizations summarizing the findings from the data analysis. In addition the host system includes a recommendation module configured to provide recommendations to increase the overall success of the meeting based on scientific findings in real time during the meeting and/or after the meeting as a summary report.

In some embodiments, the meeting metadata capture module further captures metadata related to participant location and date/time of participation.

In some embodiments, the data processing and analysis module employs diarization techniques to segment the audio data. Based on this data metrics are being calculated that have shown to be key meeting success indicators in scientific research in a variety of meeting contexts.

In some embodiments, the reporting and visualization module generates visualizations such as graphs and charts to present the analyzed data in an easily interpretable format.

In some embodiments, the reporting and visualization module furnishes meeting participants and third-parties with real-time guidance or analysis after the meeting, aiding in enhancing meeting success rates.

In conclusion, the system and method for dynamic diarization and analysis of meeting metadata in online meeting analysis represent a significant advancement in the field of audio processing and online meeting analytics. The invention has numerous applications across various domains, including remote collaboration, communication analysis, and performance evaluation in virtual environments.

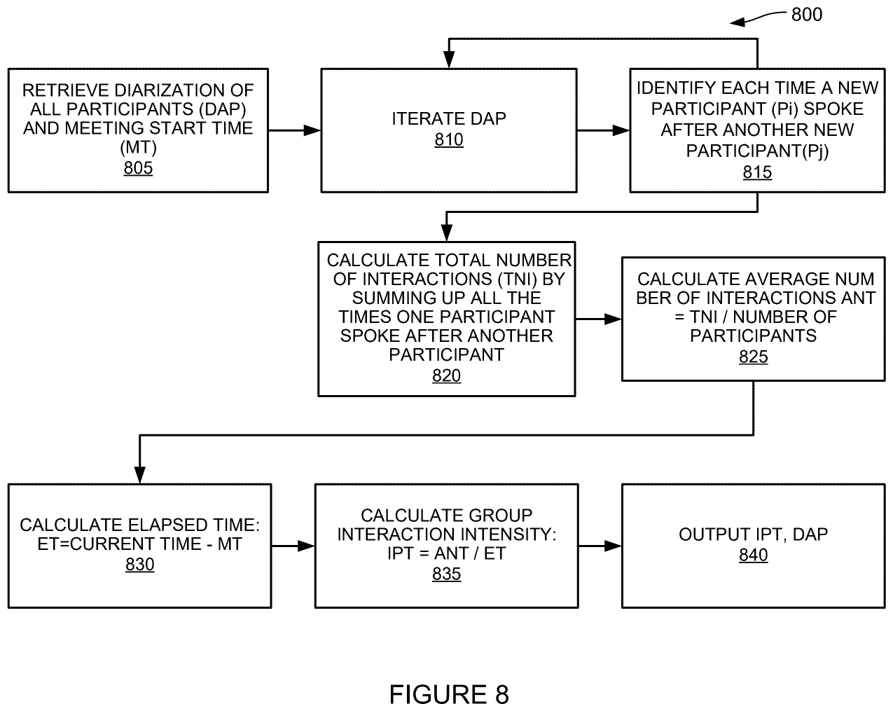

FIGS. 8-10B illustrate example processes for calculating Key Performance Indicators (KPIs) based on received diarization for use with the team performance analysis (TPA) described herein. In many embodiments, these processes occur during step S190 (shown in FIG. 1) and/or step S275 (shown in FIG. 2). In some embodiments, the processes shown in FIGS. 8-10B are performed in real-time, as the online meetings are occurring. In other embodiments, the processes shown in FIGS. 8-10B are performed offline, after the meeting has completed. In some embodiments, the KPIs introduced in FIGS. 8-10B cause one or more participants in the online meeting to change their behavior or request others to change their behavior. For example, the KPIs may indicate that one or more participants of the meeting have not spoken. This may cause a moderator, human or AI, to request that those one or more participants to speak next. The moderator may also adjust the order of speakers for the online meeting based on the KPIs.

FIG. 8 illustrates an example process 800 for calculating Key Performance Indicators (KPIs) based on received diarization. In the example embodiment, the steps of process 800 are performed by the UI 110, the provider specific backend 115, the host general purpose backend 120 (all shown in FIG. 1), and/or host server 510 (shown in FIG. 5). The steps of process 800 occur while processes 100 and/or 200 are occurring (shown in FIGS. 1 and 2, respectively). In many embodiments, process 800 occurs during step S190 (shown in FIG. 1) and/or step S275 (shown in FIG. 2). In step S805, diarization data of all meeting participants (DAP) is retrieved at a regular time intervals, such as a default interval of 0.5 seconds. The meeting start time (MT) is also retrieved S805. These may be retrieved S805 from the host datastore 125 (shown in FIG. 1). In steps S810 and S815, the diarization data structure for each participant is traversed by an algorithm that counts each time a participant (Pi) spoke after another participant (Pj). In step S820, the total number of interactions between participants (TNI) is calculated by summing up all of the times that participant (Pi) spoke after participant (Pj).

Subsequently, in step S825, the average number of interactions (ANT) is calculated by dividing the total number of interactions (TNI) by the number of participants. In step S830, the time elapsed in the meeting so far is measured in seconds, where elapsed time (ET)=current time-meeting start time (MT). Using these metrics, the intensity of group interaction (IPT) is calculated S835 by dividing the average number of interactions (ANT) by the time elapsed (ET) so far. IPT serves as a key performance indicator (KPI) for creative group work, based on empirical scientific research indicating that creativity is enhanced with many short contributions and dense interactions. The KIP is based on empirical evidence, stating that creativity in groups is increased measurably through “many short contributions rather than a few long ones” and “dense interactions: a continuous overlapping cycling between making contributions and very short (less than one second) responsive comments.” The formula used here, group interaction intensity (IPT), measures both factors.

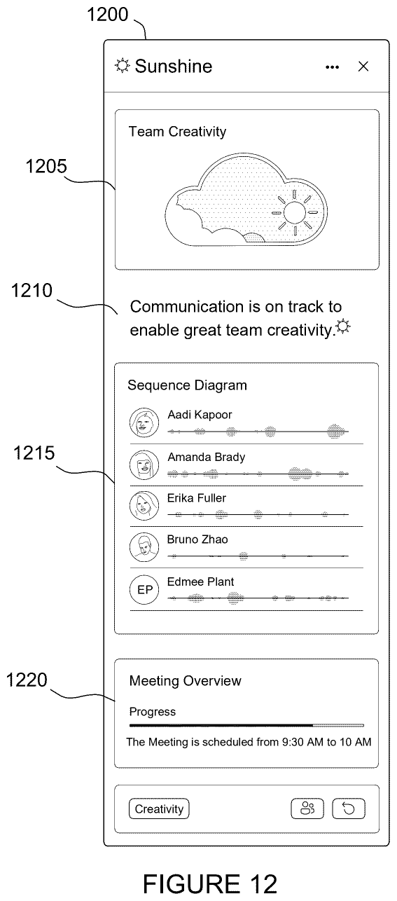

In step S840, the calculated group interaction intensity (IPT) is displayed on a dashboard, such as dashboard 1200 (shown in FIG. 12). The calculated group interaction intensity (IPT) is the main indicator displayed a weather symbol analogy, where higher IPT values correspond to a more favorable assessment 1205 (shown in FIG. 12), akin to sunnier weather. Additionally, the diarization data (DAP), detailing who spoke when and for how long, is employed to generate a bubble chart 1210 (shown in FIG. 12) on the dashboard 1200. This chart 1210 provides insights for the meeting leader or moderator, indicating participants engaged in creativity-stimulating dense interactions versus those potentially monopolizing the discussion with long monologues.

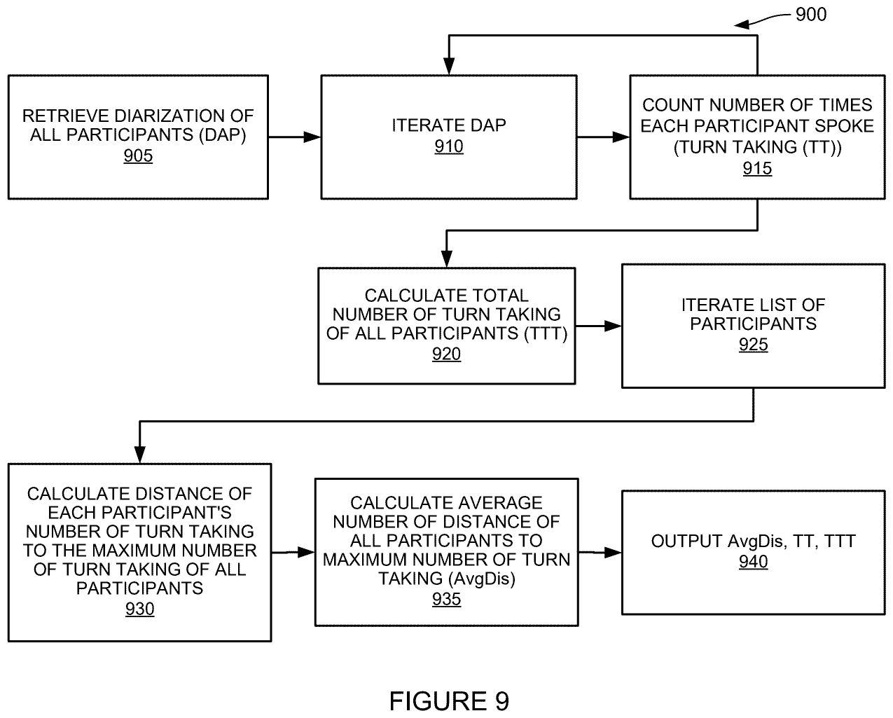

FIG. 9 illustrates an example process 900 for dynamic diarization-based group performance analysis in online meetings. In the example embodiment, the steps of process 900 are performed by the UI 110, the provider specific backend 115, the host general purpose backend 120 (all shown in FIG. 1), and/or host server 510 (shown in FIG. 5). The steps of process 900 occur while processes 100 and/or 200 are occurring (shown in FIGS. 1 and 2, respectively). In many embodiments, process 900 occurs during step S190 (shown in FIG. 1) and/or step S275 (shown in FIG. 2). Process 900 enhances the understanding of group dynamics and participant behavior by leveraging diarization data stored in the user datastore 125 (shown in FIG. 1).

In step S905, diarization data of all meeting participants (DAP) is retrieved at a regular time intervals, such as a default interval of 0.5 seconds. This data may be retrieved S905 from the host datastore 125 (shown in FIG. 1). In steps S910 and S915, the diarization data structure for each participant is traversed by an algorithm that counts each time a participant (Pi) speaks. This count allows for the calculation of the number of times each participant spoke, referred to as participant's turn taking (TT). In step S920, by summing the turn takings of all participants, the total number of times someone spoke in the meeting (TTT) is computed.

In steps S925 and S930, the process 900 iterates through the list of participants, to calculate the distance of each participant's turn taking (TT) to the maximum number of turn taking of all participants (TTT). Based on this data, the average turn taking (AvgDis) is calculated S935 based on the average distance of all participants' turn taking from the maximum number of turn taking (TTT). This AvgDis metric serves as an indicator for group intelligence, where lower AvgDis values signify better group performance.

Based on strong empirical evidence, “The largest factor in predicting group intelligence was the equality of conversational turn taking.” This is used as KPI here. However, the operationalization of this factor as reverse variance of turn taking (the lower the variance, the better) found in the study of onsite groups of around 5 people needs to be adapted to fit to online video conferences of various group sizes. Therefore, a different metric to measure “turn taking” was chosen: the reverse average distance to the maximum of turn taking within the group (AvgDis).

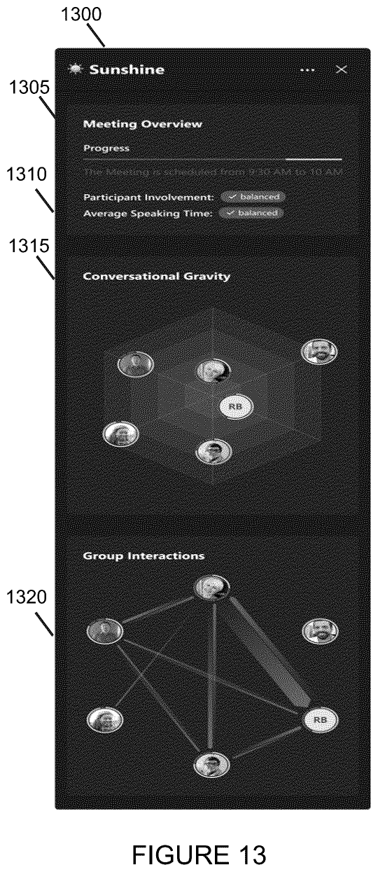

Additionally, the system generates a dashboard 1300 (shown in FIG. 13) to present these key performance indicators (KPIs) to users. A dashboard 1300 can be any design or configuration that a user would like to employee in the system. An example of a dashboard 1300, which can be employed, is shown in FIG. 13. The dashboard 1300 utilizes a weather symbol analogy 1305 (shown in FIG. 13), where a sunnier depiction indicates better group intelligence. This visual representation provides users with a quick understanding of the overall meeting performance.

Furthermore, the TT metric is utilized to identify deviations from the average turn taking, allowing the moderator or leader of the meeting to discern which team members may need encouragement to speak more or less to optimize team performance.

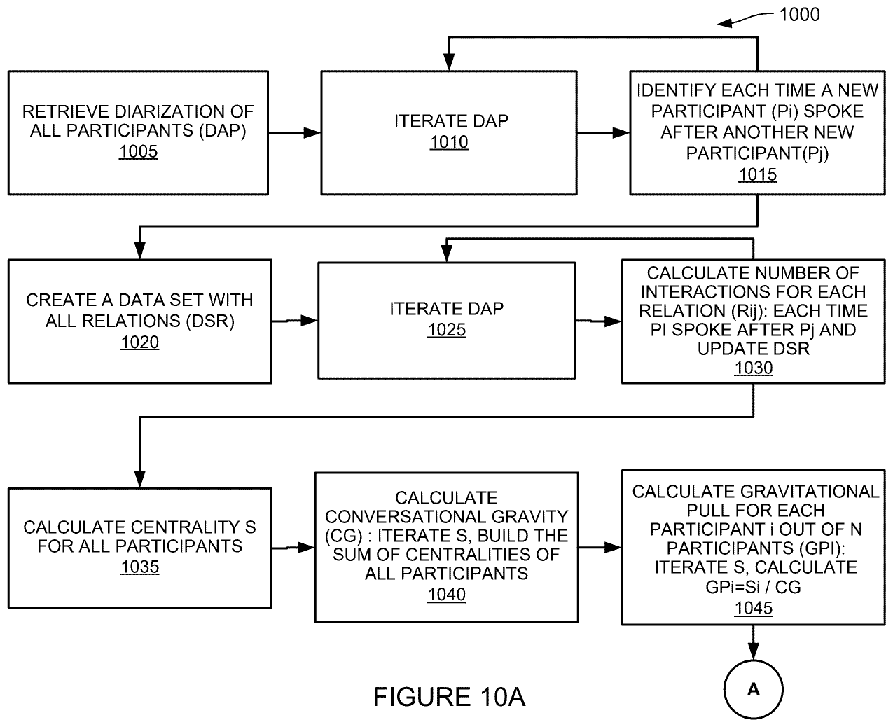

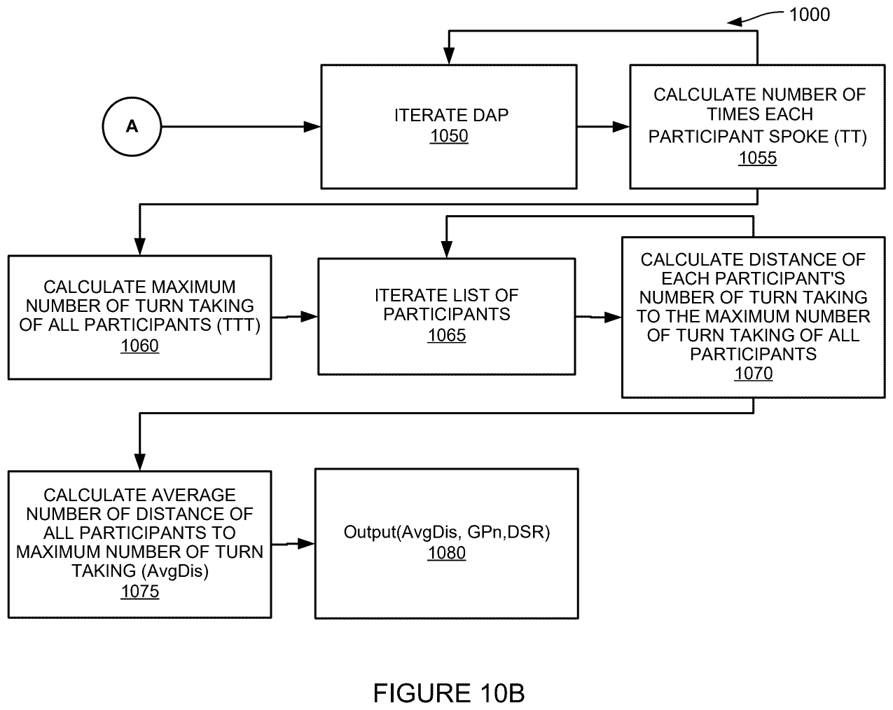

FIGS. 10A and 10B illustrate an example process 1000 for assessing group interaction dynamics and visualizing conversational gravity within an online meeting environment. In the example embodiment, the steps of process 1000 are performed by the UI 110, the provider specific backend 115, the host general purpose backend 120 (all shown in FIG. 1), and/or host server 510 (shown in FIG. 5). The steps of process 1000 occur while processes 100 and/or 200 are occurring (shown in FIGS. 1 and 2, respectively). In many embodiments, process 1000 occurs during step S190 (shown in FIG. 1) and/or step S275 (shown in FIG. 2). Process 1000 enhances the understanding of group intelligence and individual participation dynamics by leveraging diarization data stored in the user datastore 125 (shown in FIG. 1).

In step S1005, diarization data of all meeting participants (DAP) is retrieved at a regular time intervals, such as a default interval of 0.5 seconds. This data may be retrieved S1005 from the host datastore 125 (shown in FIG. 1). In steps S1010 and S1015, the diarization data structure for each participant is traversed by an algorithm that identifies and counts each time a new participant (Pi) spoke after another new participant (Pj). In step S1020, a data set with all relations (DSR) is created.

In steps S1025 and S1030, the diarization data structure for each participant is traversed by an algorithm that calculates the number of interactions for each relation (Rij), aka each time that Pi spoke after Pj. The DSR is updated with this information.

In step S1035 centrality S is calculated for all participants. A relation differs from a tie as it reflects a social aspect between two actors that is relevant to the entire network. It is “the measurement of different ties in an overall network.” Relations in these meetings reflect the interaction between two actors over the course of the meetings. This relationship is categorized by when one participant spoke after another participant. They are weighted as follows: the higher the number of interactions, the higher the weight of the relation. Accordingly, the relation between P₁ and P₂ is defined as:

$${R}_{12} = \frac{{\sum }_{t = 1}^{n} {t}_{n} + {t}_{12}}{n} \qquad EQ . 1$$

where n is the number of interactions where P1 spoke after P2.

Based on this, the degree centrality of each team member can be calculated. As the network is constructed using a graph with weighted nodes (with the relation R as described above), the information of the weights can be taken into account when calculating the centrality measure. In one embodiment, a suitable way to compute degree centrality for social networks with weighted nodes is as follows:

$${S}_{t} = {\sum }_{j = 0}^{3} {w}_{i j} \qquad EQ . 2$$

where m is the total number of nodes, w is the weighted adjacency matrix, in which wᵢⱼ is greater than 0 if node i is connected to node j, and the value represents the weight of the tie.

In other embodiments, one having skill in the art that alternate definitions for centrality in social networks with weighted nodes may be used. For example, the centrality definition of “the number of nodes that a focal node is connected to, and the average weight to these nodes adjusted by the tuning parameter, for instance, takes both the weight of the nodes as well as the number of relations an actor has into account. This can be advantageous when we have a network with a very uneven number of relations between its actors. However, this comes at a price: this metric requires a parameter alpha to balance the relevance of node weight and the number of relations. This increases the complexity of the metric and requires empirical work to justify which value to use for alpha in what context. Another approach is to view role positions based on the number of incoming ties, seeing a prestigious actor as one to whom many ties are directed. This forms a concept that has been carried on, for instance, to define centrality in asymmetric networks. Other centrality measures cater to complex networks with subgroups.

In step S1040, the system calculates conversational gravity (CG). Then the system iterates S and builds the sum of all centralities of all of the participants. In step S1054, the system calculates gravitational pull for each participant i out of n participants (GPi). The system iterates S and calculates GPi as Si/CG.

In steps S1050 and S1055, the diarization data structure for each participant is traversed by an algorithm that calculates the number of times that each participant spoke, aka turn taking for each participant (TT). The system calculates S1060 the maximum number of turn taking of all participants (TTT).

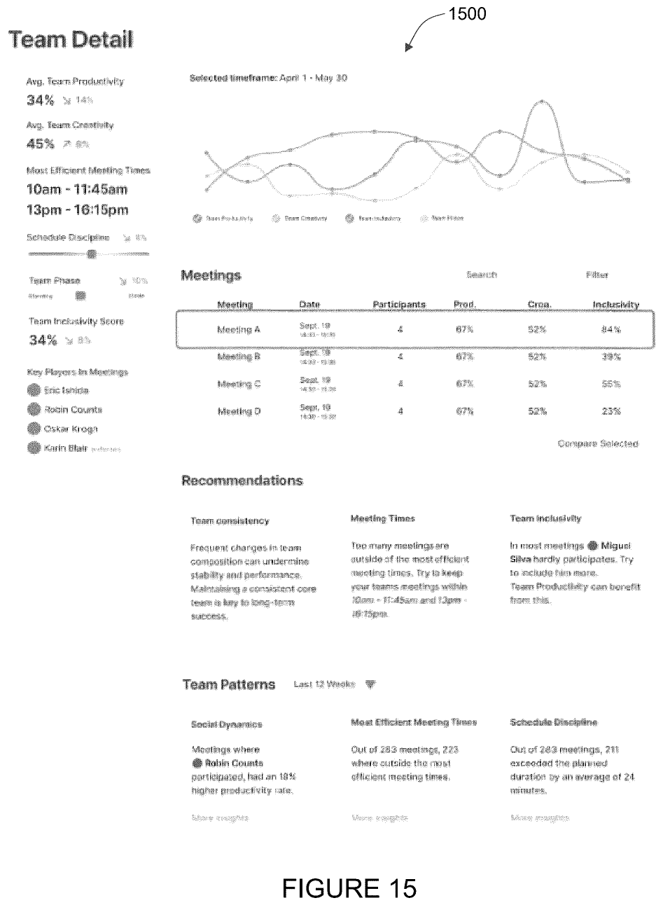

In steps S1065 and S1070, the diarization data structure for each participant is traversed by an algorithm that calculates the distance of each participant's number of turn taking to the maximum number of all turn taking of all of the participants. Then the system calculates S1075 the average distance of all participants to the maximum number of turn taking (AvgDis). In step S1080, the AvgDis, the GPn, and the DSR are displayed on a dashboard, such as dashboard 1500 (shown in FIG. 15), for example. This AvgDis metric serves as a key performance indicator (KPI) for assessing group intelligence and is prominently displayed in the upper part of the dashboard.

Furthermore, centrality metrics are computed for each participant, along with the relational dynamics between all participants. These metrics are utilized to generate a group interaction diagram, where each participant is represented as a node, and the edges between nodes depict directed relations. The size of each node corresponds to the relative airtime of the participant, while the thickness of edges reflects the frequency of interactions between participants during the meeting.

Additionally, the ratio of centrality to total centrality is computed for each participant to derive conversational gravity (GPn) visualization. This visualization portrays the centrality of each participant in the conversation, with participants closer to the center of the chart indicating greater centrality. The concept of centrality is metaphorically depicted as gravitational pull towards the center of the conversation, providing an intuitive understanding of participant dynamics within the group interaction.

The volatility of centrality of group members gives an indication in what phase the team building is in: if the volatility decreases, this is an indication that the team moves from a storming to a norming and subsequently to a performing phase (as defined in the group dynamic models of Bruce Wayne Tucker and Raul Schindler). This is reflected by the formula used to calculate Conversational Gravity (GPn) in a meeting with n team members. The less Conversational Gravity changes over time, the more stable the roles in the team are becoming, and the more the team is moving towards a performing phase.

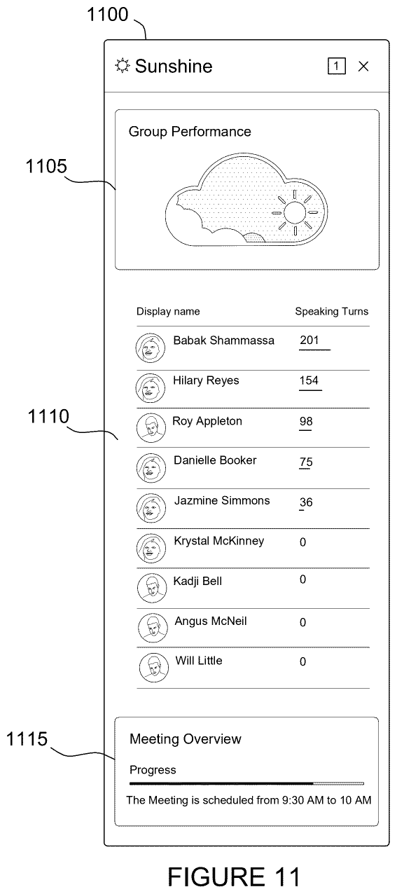

FIG. 11 illustrates an example dashboard 1100 for use with processes 800 and 900 (shown in FIGS. 8 and 9), for example. Dashboard 1100 depicts an example of a group performance indicator 1105, a Group Performance Weather Indicator, a visual representation of reverse average distance to the maximum of turn taking (AvgDis). The lower the AvgDis, the better. The dashboard 1100 utilizes a weather symbol analogy, where a sunnier depiction indicates better group intelligence. This visual representation 1105 provides users with a quick understanding of the overall meeting performance. This is abstracted to four weather scenarios (sunny, partly cloudy, cloudy, and rainy). A middle indicator 1110 display the absolute number of speaking turns of all meeting participants (TT). A bottom indicator 1115 displays meeting progress as the current status of the meeting in relation to its scheduled duration.

Furthermore, the TT metric is utilized to identify deviations from the average turn taking, allowing the moderator or leader of the meeting to discern which team members may need encouragement to speak more or less to optimize team performance.

FIG. 12 illustrates an example dashboard 1200 for use with processes 800 and 900 (shown in FIGS. 8 and 9), for example. Dashboard 1200 depicts an example of a group interaction participant indicator 1205, a Team Creativity Weather Indicator, a visual representation of group interaction intensity (IPT). This indicator 1205 measures the interaction intensity relative to the number of participants per minute, presented through various weather scenarios (sunny, partly cloudy, cloudy, rainy). This indicator 1205 serves to illustrate the density of overall interaction, with sunnier conditions indicating a higher intensity of interaction among participants.

Additionally, dashboard 1200 portrays a visualization 1210 each user's speaking times 1210 relative to the meeting's timeline. In this diagram, larger bubbles represent longer durations of speech, based on the diarization of all participants (DAP). This visualization 1210 aids in understanding the distribution of speaking time among participants throughout the meeting.

Moreover, a meeting progress indicator 1215 displays the current status of the meeting in relation to its scheduled duration. This component 1215 provides real-time feedback on the progress of the meeting, enabling participants to gauge how much time remains and adjust their contributions accordingly.

FIG. 13 illustrates an example dashboard 1300 for use with process 1000 (shown in FIGS. 10A and 10B), for example. Dashboard 1300 is designed to provide comprehensive insights into group dynamics and meeting progress, facilitating efficient management and assessment of collaborative sessions. The dashboard 1300 integrates various visual elements and metrics to offer a holistic view of participant involvement, meeting progression, and group intelligence indicators.

The primary feature of the dashboard is the graphical representation of group dynamics, which includes multiple components:

A Meeting Progress Indicator 1305 visualizes the ratio of elapsed time to scheduled time, expressed as a percentage. This provides a real-time view of how much of the meeting time has been used relative to the total scheduled duration. It allows meeting facilitators to monitor time allocation and adherence to the agenda, enabling timely adjustments as needed.

Participant Involvement Abstracts 1310 utilize reverse average distance to the maximum of turn-taking (AvgDis), participant involvement is abstracted into a text-based representation. This representation 1310 categorizes participant involvement as balanced, mixed, or unbalanced, providing a quick assessment of the distribution of speaking opportunities among meeting attendees. This feature aids in identifying potential imbalances in participation and encourages equitable engagement. The Participant Involvement Abstracts 1310 also include Airtime Distribution, which showcases the distribution of airtime among meeting participants, offering insights into individual contributions and overall participation dynamics. By highlighting disparities or dominance in speaking time, this feature contributes to the assessment of group intelligence and facilitates interventions to promote inclusive discussions.

Conversational Gravity (GPn) Visualization 1315 incorporates a visual representation of conversational gravity, indicating the centrality of each user among the total users in the meeting. Participants closer to the center of the visualization 1415 exhibit higher centrality, reflecting their influence and engagement within the conversation. This visualization 1415 enhances understanding of participant dynamics and facilitates targeted engagement strategies.

Group Interactions Visualization 1320 is based on the intensity of relationships between all participants, as measured by their interactions in the meeting (DSR). This visualization 1320 illustrates the dynamics of group interactions. By visualizing the strength and frequency of interactions, this component 1320 offers insights into communication patterns, alliances, and potential conflicts within the group.

Overall, the dashboard 1300 serves as a comprehensive tool for monitoring and optimizing group dynamics, fostering effective collaboration, and maximizing meeting outcomes.

These dashboards 1100, 1200, and 1300 present KPIs and trends in an easily interpretable format. A key feature includes that these are Interactive dashboards and provide Visualizations such as charts, graphs, and heatmaps displaying participant contributions and team dynamics. Another key feature includes performance indicators, such as Metrics like TTT (Total Turn-Takings) and AvgDis (Average Distance from Turn-Taking Mean) are used to assess participation balance. A Creativity Weather Indicator uses a weather analogy dashboard (e.g., sunny vs. rainy) to visualize interaction intensity, reflecting group creativity. A further key feature is a progress tracker that tracks meeting progress against the agenda to help facilitators manage time and contributions. These visual tools help managers quickly identify trends and optimize team interactions during future meetings.

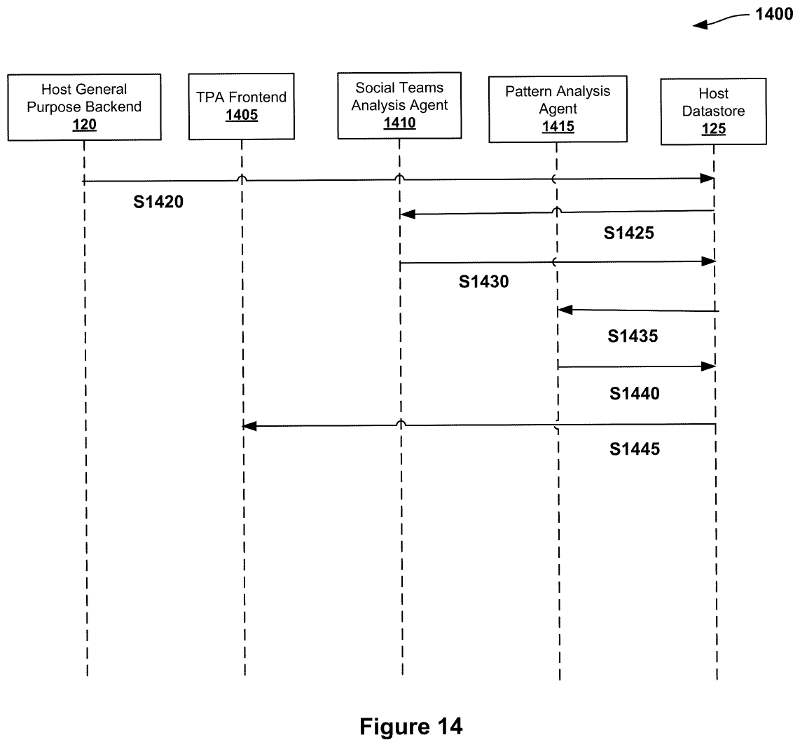

FIG. 14 illustrates a team performance analysis (TPA) system 1400 in accordance with at least one embodiment. The TPA system 1400 may be a part of system 100 (shown in FIG. 1). The team performance analysis (TPA) system 1400 addresses the need for precision in assessing critical factors such as communication effectiveness, group dynamics, and productivity in monitoring team performance. The TPA system 1400 provides data-driven insights into team productivity, creativity, efficiency, and group dynamics. The TPA system 1400 offers actionable recommendations to enhance team performance through interventions like team development activities or leadership coaching. The TPA system 1400 also empowers organizational leaders and HR experts with the ability to benchmark team performance across departments and monitor it over time.

The TPA system 1400 is designed to capture and analyze communication patterns that strongly correlate with team performance. These patterns are identified based on scientific theories, empirical studies, and practical field research. By employing advanced machine learning and diarization techniques, the TPA system 1400 processes meeting data to extract key insights and generate recommendations to improve collaboration and effectiveness.

The TPA system 1400 allows leaders and HR experts to: A) Monitor individual and team performance over time; B) Benchmark performance across teams; and C) Receive data-backed recommendations for leadership coaching and team development. The TPA system 1400 supports a team dashboard, such as, but not limited to, dashboards 1100, 1200, and 1300 (shown in FIGS. 11, 12, and 13) that displays a plurality of Team KPIs (key performance indicators). In the example embodiment, these KPIs are calculated by a pattern analysis agent 1415 described herein. These team KPIs include, but are not limited to, Average Team Productivity, Average Team Creativity, Schedule Discipline, Team Phase, Team Inclusivity, and Key Players. Average Team Productivity is a statistical mean of the meeting productivity KPI across all meetings of the respective team in the defined time span. Average Team Creativity is the statistical mean of the meeting creativity KPI across all meetings of the respective team in the defined time span. Schedule Discipline is the statistical mean of exceeded meeting time across all meetings for the respective team in the given time. Team Phase is the mean variance of changes of centrality per team member over time. This is clustered into two predetermined segments of storming and norming/performing. Team Inclusivity is the reverse variance of the average centrality of team members across all meetings. Key Players include the n team members (n configurable by default to 4) with the highest average centrality across all meetings.

The TPA system 1400 uses the following metrics to provide a detailed understanding of team performance: Turn-Taking (TT), Total Turn-Takings (TTT), Average Distance from Turn-Taking Mean (AvgDis), Group Intelligence Index (GII), and Conversational Gravity (GP). Turn-Taking (TT) is the number of times each participant spoke within a time span. Total Turn-Takings (TTT) are the sum of all participants' speaking instances. Average Distance from Turn-Taking Mean (AvgDis) measures the variance in participant contributions, with smaller distances indicating balanced participation and higher group intelligence. Group Intelligence Index (GII) calculates by dividing total speaking instances by the meeting duration, providing insights into interaction density. Conversational Gravity (GP) includes the centrality of a participant's contributions compared to others, helping to identify key influencers. These metrics are incorporated into the TPA system 1400 which allow HR experts and managers to benchmark teams and develop personalized coaching strategies.

The TPA system 1400 operations and data flow is described herein. The TPA system 1400 starts with meeting initiation where the TPA system 1400 begins capturing metadata as soon as a meeting is initiated via an online platform like Zoom or Microsoft Teams. Then the TPA system 1400 begins data capture and transmission, where provider-specific backend extracts participant location and timestamp metadata. The TPA system 1400 continuously captures audio streams, with metadata (e.g., pitch, volume) extracted in real-time. The TPA system 1400 uses diarization, where diarization segments the audio stream to attribute speech segments to individual participants. The TPA system 1400 preforms performance analysis. The backend 120 calculates KPIs such as RST, TTT, GII, and GP using real-time diarization data. Then the TPA system 1400 uses visualization and feedback. The UI 110 (shown in FIG. 1) polls the backend for updated KPIs and presents them in dashboards and reports. Managers receive real-time recommendations to enhance team performance and collaboration.

The TPA system 1400 also provides recommendation generation. The TPA system 1400 generates actionable recommendations based on trends in participation and performance, such as suggesting team development activities or leadership coaching. During a virtual brainstorming session, the TPA system 1400 captures participant speaking patterns and calculates the Group Creativity Index (IPT) based on the frequency and density of interactions. The TPA system 1400 detects that one participant monopolized the conversation with long monologues, which reduced interaction density. The TPA system 1400 suggests to the meeting organizer that encouraging shorter, more frequent contributions could enhance creativity in future sessions.

The TPA system 1400 offers several advantages. One advantage is enhanced monitoring that provides ongoing insights into team performance over time. A further advantage includes personalized coaching recommendations such as delivering actionable insights for leadership development. Another advantage includes benchmarking capabilities that allows HR to compare team performance across departments. Additionally, an advantage includes real-time feedback that empowers managers with timely insights during meetings.

The TPA system 1400 is applicable across various industries, including corporate organizations, educational institutions, and remote work environments, to enhance collaboration and optimize team performance.

The TPA system 1400 provides valuable insights on KPIs regarding team performance. This includes productivity, creativity, efficiency, and group dynamics. Furthermore, it gives recommendations on how team performance can be improved by, for instance, means of team developments or leadership coaching. The TPA system 1400 enables leaders and HR experts organization-wide to monitor team performance over time, to benchmark team, and how to receive information about team patterns and recommendations how to improve team performance. This improvement of team performance by measuring those communication patterns that strongly correlate with team performance. Correlations, that are strongly founded in scientific theory, empirical evidence, and practical field studies.

FIG. 14 illustrates the team performance analysis (TPA) workflow for generating and visualizing team performance data through a sequence diagram. FIG. 14 outlines how meeting data is captured, stored, analyzed, and visualized to provide actionable insights to users. This process involves multiple agents and data flows, utilizing advanced machine learning techniques to detect communication patterns, infer informal team structures, and generate KPIs and recommendations.

In the example embodiment, the host general purpose backend 120 of the TPA system 1400 stores S1420 the diarization data of an online meeting in the host datastore 125. In some embodiments, at the conclusion of each meeting, the general purpose backend 120 stores S1420 the entire diarization data in the host datastore 125. The diarization data captures the sequence of speaking turns, the identity of speakers, and timestamps, forming the basis for detecting communication patterns. This is to store granular data on individual contributions and participation to analyze team dynamics and performance post-meeting.

The team analysis agent 1410 infers the team structure. The team analysis agent 1410 retrieves S1425 all meetings and their corresponding participants from the host datastore 125. Using participant attendance data, the agent 1410 infers informal team structures by identifying recurring participation patterns (e.g., which employees often work together). Then the team analysis agent 1410 stores S1430 the inferred team structures and team members back in the host datastore 125 for future retrieval. In some embodiments, each employee may belong to multiple informal teams simultaneously, based on their participation across different meetings. This flexible logic reflects the dynamic nature of modern work environments.

A pattern analysis agent 1415 performs pattern detection and KPI calculation. The pattern analysis agent 1415 retrieves S1435 team data from the host datastore 125. In some embodiments, the pattern analysis agent 1415 extracts S1430 the following from the host datastore 125: Teams and their members, Team KPIs (Key Performance Indicators), All meetings per team, and Meeting KPIs (such as Turn-Taking metrics, Group Intelligence, and Conversational Gravity).

The pattern analysis agent 1415 applies unsupervised machine learning algorithms to identify recurring team patterns based on meeting attendance and interaction dynamics. The pattern analysis agent 1415 generates KPI calculations and recommendations. The pattern analysis agent 1415 calculates Team KPIs to assess team performance across various dimensions (e.g., participation balance, creativity, communication effectiveness). The pattern analysis agent 1415 generates team recommendations based on detected patterns, such as suggestions for team-building exercises or leadership coaching. The pattern analysis agent 1415 stores S1440 all detected team patterns, calculated KPIs, and generated recommendations are stored in the host datastore 125. A key objective is using data-driven insights to generate actionable recommendations that can improve team performance and alignment over time.

The TPA frontend 1405 performs S1445 data retrieval and visualization. The TPA frontend 1405 retrieves S1445 data from the host datastore 125. The data includes, but is not limited to, Team patterns, Team KPIs, and Team recommendations. The data is presented through an interactive TPA Dashboard. Users can explore team structures, performance trends, and recommendations through visual elements such as charts, graphs, and heatmaps. The dashboard provides a holistic view of each team's performance, enabling users to compare KPIs across teams and track improvements over time. This visualization empowers HR professionals, managers, and team leaders to take proactive steps based on real-time insights from the TPA dashboard.

The general purpose backend 120 stores S1420 diarization data at the end of each meeting for later analysis. The host datastore 125 acts as the central repository where all meeting, team, and performance data is stored and accessed. The team analysis agent 1410 infers informal team structures based on meeting participation data and stores the results. The pattern analysis agent 1415 detects team patterns using unsupervised machine learning, calculates KPIs, and generates performance recommendations. The TPA frontend 1405 retrieves and visualizes the data, displaying it on the TPA Dashboard for actionable insights.

An End-to-End Data Flow Summary includes Meeting Data Capture where Diarization data is captured and stored; Team Structure Inference where Informal teams are inferred based on meeting attendance; Pattern Analysis and KPI Generation where Patterns are detected, KPIs calculated, and recommendations generated; and Visualization where the TPA dashboard 1500 presents KPIs, patterns, and recommendations to users.

FIG. 14 illustrates a sequence diagram that captures the data flow from meeting conclusion to actionable insights on the TPA dashboard. By leveraging machine learning for pattern detection and KPI analysis, the TPA system 1400 provides organizations with deep insights into team dynamics. The TPA system 1400 empowers leaders and HR professionals to make data-driven decisions, promoting collaboration and continuous performance improvement.

The team performance analysis (TPA) Dashboard provides an analytical view of team performance through Team Recommendations, Team Patterns, and various Team KPIs. These KPIs are computed by the pattern analysis agent using machine learning techniques and statistical methods applied to meeting data over defined time spans. The TPA dashboard allows managers and decision-makers to monitor productivity, creativity, discipline, inclusivity, and other factors critical to team performance.

The TPA dashboard and KPI computation illustrates the pattern analysis agent 1415 retrieves S1435 meeting data from the datastore 125 and computes various KPIs for each team. These KPIs reflect key aspects of team dynamics and performance over time. The computed KPIs and related team insights are displayed on the TPA Dashboard to provide actionable insights for improving team efficiency.

The TPA system 1400 supports a team dashboard, such as, but not limited to, dashboards 1100, 1200, and 1300 (shown in FIGS. 11, 12, and 13) that displays a plurality of Team KPIs (key performance indicators). In the example embodiment, these KPIs are calculated by a pattern analysis agent 1415 described herein. These team KPIs include, but are not limited to, Average Team Productivity, Average Team Creativity, Schedule Discipline, Team Phase, Team Inclusivity, and Key Players. Average Team Productivity is a statistical mean of the meeting productivity KPI across all meetings of the respective team in the defined time span. Average Team Creativity is the statistical mean of the meeting creativity KPI across all meetings of the respective team in the defined time span. Schedule Discipline is the statistical mean of exceeded meeting time across all meetings for the respective team in the given time. Team Phase is the mean variance of changes of centrality per team member over time. This is clustered into two predetermined segments storming and norming/performing. Team Inclusivity is the reverse variance of the average centrality of team members across all meetings. Key Players include the n team members (n configurable by default to 4) with the highest average centrality across all meetings.

FIG. 15 illustrates a TPA dashboard 1500 for the TPA system 1400 (shown in FIG. 14). The TPA dashboard 1500 with Team Recommendations. Based on the KPIs and detected patterns, the pattern analysis agent 1415 provides recommendations, which include, but are not limited to: Improvement suggestions for productivity and creativity; Alerts about schedule discipline issues; Coaching suggestions during storming phases; and Team-building activities for enhancing inclusivity.

The pattern analysis agent 1415 retrieves S1435 raw meeting data from the datastore 125. The agent 1415 computes the KPIs and stores S1440 them in the datastore 125. The TPA frontend 1405 fetches S1445 the computed KPIs, patterns, and recommendations for display. The TPA frontend 1405 controls the TPA dashboard 1500. Authorized users access the TPA dashboard 1500 to monitor team performance and act on the recommendations.

The TPA system 1400 is for capturing and analyzing communication patterns by dynamically generating and analyzing metadata for online meetings. The TPA system 1400 includes a computer device 510 includes at least one processor 705 in communication with at least one memory device 710. The at least one memory device 710 stores computer-implemented instructions that cause the at least one processor 705 to perform the steps described herein.

In at least one embodiment, TPA system 1400 receives audio stream of an online meeting. The audio stream includes a plurality of participants on a team participating in the online meeting.

In at least one embodiment, TPA system 1400 extracts a plurality of metadata from the audio stream.

In at least one embodiment, TPA system 1400 performs diarization on the audio stream and the plurality of metadata the audio stream to generate diarization information. The diarization information includes information about participation for the plurality of participants on the team in the online meeting. The diarization information includes participation sequences of the plurality of participants. The diarization data includes timestamps that allow analysis of turn-taking patterns between participants to detect conversational dynamics.

In at least one embodiment, TPA system 1400 analyzes the diarization information to detect communication and team patterns.

In at least one embodiment, TPA system 1400 calculates one or more team performance key performance indicators (KPIs) based on the detected communication and team patterns. The one or more team performance KPIs include metrics such as collaboration levels, response times, conversational equity, and meeting participation balance. The one or more team performance KPIs include at least one of Average Team Productivity, Average Team Creativity, Schedule Discipline, Team Phase, Team Inclusivity, and Key Players. The one or more team performance KPIs are clustered into storming and norming/performing phases based on the variance of team members' centrality over time. The one or more team performance KPIs include a group interaction intensity based on an average number of interactions for the plurality of participants in the online meeting. In some embodiments, the one or more team performance KPIs are calculated subsequent to completion of the online meeting and transmitted to one or more participants of the online meeting.

In at least one embodiment, TPA system 1400 generates recommendations for the team based on the detected communication and team patterns.

In at least one embodiment, TPA system 1400 generates visualization of the one or more team performance KPIs and the recommendations.

In some further embodiments, the TPA system 1400 infers informal team structures based on recurring meeting attendance. The team structures are dynamic and allow for employees to belong to multiple teams simultaneously based on attendance patterns.

In some further embodiments, the TPA system 1400 uses an unsupervised machine learning model to detect communication and team patterns. The unsupervised machine learning model is selected from the group consisting of: Clustering algorithms for grouping related patterns; Principal component analysis (PCA) for reducing dimensionality of data; and Hidden Markov models for detecting sequential behavioral patterns.

In some further embodiments, the TPA system 1400 executes a frontend dashboard to display the visualization of the one or more team performance KPIs and the recommendations using graphs, heatmaps, timelines, and performance comparison charts.

In some further embodiments, backend and frontend components are integrated through a cloud-based platform that allows remote access to the TPA dashboard 1500 by authorized users.

In some further embodiments, the TPA system 1400 use unsupervised machine learning algorithms to identify team patterns and trends.

In some further embodiments, the TPA system 1400 generate a user interface to display the group interaction intensity as a weather symbol analogy.

In some further embodiments, the TPA system 1400 also includes a general-purpose backend module configured to capture and store diarization data from meetings, including, participation sequences, and timestamps, in a datastore 125.

In some further embodiments, the TPA system 1400 also includes a team analysis agent module configured to retrieve meeting records and participants from the datastore 125, infer informal team structures based on recurring meeting attendances, and store inferred team structures and their members in the datastore 125.

In some further embodiments, the TPA system 1400 also includes a pattern analysis agent module configured to retrieve team structures, meeting data, team KPIs, and participant information from the datastore 125, use unsupervised machine learning to detect communication and team patterns, calculate team performance KPIs based on the detected patterns, and generate performance recommendations for each team.

In some further embodiments, the TPA system 1400 also includes a frontend dashboard configured to retrieve team patterns, KPIs, and recommendations from the datastore 125.

In some further embodiments, the TPA system 1400 also includes a meeting metadata capture module configured to collect data generated during online meetings, including participant speaking patterns and audio characteristics.

In some further embodiments, the TPA system 1400 also includes a data processing and analysis module configured to process captured metadata using machine learning algorithms and statistical techniques to extract insights regarding participant behavior and group dynamics and generate meeting success indicators.

In some further embodiments, the TPA system 1400 also includes a reporting and visualization module configured to generate reports and visualizations summarizing findings from data analysis.

In some further embodiments, the TPA system 1400 also includes a recommendation module configured to provide recommendations to increase overall success of the online meeting based on scientific findings at least one of in real time during the online meeting and after the online meeting as a summary report.

In some further embodiments, the TPA system 1400 generates team recommendations include suggestions for leadership coaching to improve team effectiveness; proposals for team-building activities to enhance collaboration; and real-time alerts identifying teams at risk of underperformance. The recommendations are tailored based on historical team patterns, enabling predictive insights into future team performance.

In some further embodiments, the TPA system 1400 also includes a data anonymization module that anonymizes participant identities before storing or processing the diarization data to protect employee privacy. All communication between the backend, pattern analysis agent, and frontend dashboard is encrypted using industry-standard protocols to ensure data security.

In some further embodiments, the TPA system 1400 instructs the TPA frontend dashboard 1500 to display KPIs using graphs, charts, heatmaps, and performance trend lines.

In some further embodiments, the TPA system 1400 the pattern analysis agent 1415 provides recommendations based on the detected team patterns, including: suggestions for improving productivity and creativity, alerts for schedule discipline issues, and coaching strategies for teams in storming phases.

In some further embodiments, the TPA system 1400 tailors the recommendations based on historical trends in the Team Phase KPI to predict future team behavior.

In some further embodiments, all participant data is anonymized to protect employee privacy during KPI computation.

In some further embodiments, communication between the pattern analysis agent and the frontend dashboard is encrypted using end-to-end encryption protocols.

In conclusion, the system and method for capturing and analyzing communication patterns by dynamically generating and analyzing metadata for online meetings for teams described herein represent a significant advancement in the field of audio processing and online meeting analytics. The invention has numerous applications across various domains, including remote collaboration, communication analysis, and performance evaluation in virtual environments.

### ADDITIONAL CONSIDERATIONS

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for capturing and analyzing communication patterns by dynamically generating and analyzing metadata for online meetings, the system comprising a computer device comprising at least one processor in communication with at least one memory device, wherein the at least one memory device stores computer-implemented instructions that cause the at least one processor to:
receive an audio stream of an online meeting, wherein the audio stream includes a plurality of participants on a team participating in the online meeting;
extract a plurality of metadata from the audio stream;
perform diarization on the audio stream and the plurality of metadata the audio stream to generate diarization information, wherein the diarization information includes information about participation for the plurality of participants on the team in the online meeting;
analyze the diarization information to detect communication and team patterns;
calculate one or more team performance key performance indicators (KPIs) based on the detected communication and team patterns;
generate recommendations for the team based on the detected communication and team patterns; and
generate visualization of the one or more team performance KPIs and the recommendations.

2. The system of claim 1, wherein the diarization information includes participation sequences of the plurality of participants.

3. The system of claim 1, wherein the at least one processor is further programmed to infers informal team structures based on recurring meeting attendance.

4. The system of claim 3, wherein the team structures are dynamic and allow for employees to belong to multiple teams simultaneously based on attendance patterns.

5. The system of claim 1, wherein the at least one processor is further programmed to use an unsupervised machine learning model to detect communication and team patterns.

6. The system of claim 5, wherein the unsupervised machine learning model is selected from the group consisting of: clustering algorithms for grouping related patterns; principal component analysis (PCA) for reducing dimensionality of data; and hidden Markov models for detecting sequential behavioral patterns.

7. The system of claim 1, wherein the diarization information includes timestamps that allow analysis of turn-taking patterns between participants to detect conversational dynamics.

8. The system of claim 1, wherein one or more team performance KPIs include metrics such as collaboration levels, response times, conversational equity, and meeting participation balance.

9. The system of claim 1, wherein the at least one processor is further programmed to execute a frontend dashboard to display the visualization of the one or more team performance KPIs and the recommendations using graphs, heatmaps, timelines, and performance comparison charts.

10. The system of claim 1, wherein backend and frontend components are integrated through a cloud-based platform that allows remote access to a team performance analysis (TPA) dashboard by authorized users.

11. The system of claim 1, wherein the at least one processor is further programmed to use unsupervised machine learning algorithms to identify team patterns and trends.

12. The system of claim 1, wherein the one or more team performance KPIs include at least one of Average Team Productivity, Average Team Creativity, Schedule Discipline, Team Phase, Team Inclusivity, and Key Players.

13. The system of claim 1, wherein the one or more team performance KPIs are clustered into storming and norming/performing phases based on a variance of team members' centrality over time.

14. The system of claim 1, wherein the one or more team performance KPIs include a group interaction intensity based on an average number of interactions for the plurality of participants in the online meeting.

15. The system of claim 14, wherein the at least one processor is further programmed to generate a user interface to display the group interaction intensity as a weather symbol analogy.

16. The system of claim 1, wherein the one or more team performance KPIs are calculated subsequent to completion of the online meeting and transmitted to one or more participants of the online meeting.

17. The system of claim 1, further comprising:
a general-purpose backend module configured to capture and store diarization data from meetings, including, participation sequences, and timestamps, in a datastore;
a team analysis agent module configured to retrieve meeting records and participants from the datastore, infer informal team structures based on recurring meeting attendances, and store inferred team structures and their members in the datastore;
a pattern analysis agent module configured to retrieve team structures, meeting data, team KPIs, and participant information from the datastore, use unsupervised machine learning to detect communication and team patterns, calculate team performance KPIs based on the detected patterns, and generate performance recommendations for each team; and
a frontend dashboard configured to retrieve team patterns, KPIs, and recommendations from the datastore.

18. The system of claim 1, further comprising:
a meeting metadata capture module configured to collect data generated during online meetings, including participant speaking patterns and audio characteristics;
a data processing and analysis module configured to process captured metadata using machine learning algorithms and statistical techniques to extract insights regarding participant behavior and group dynamics and generate meeting success indicators;
a reporting and visualization module configured to generate reports and visualizations summarizing findings from data analysis; and
a recommendation module configured to provide recommendations to increase overall success of the online meeting based on scientific findings at least one of in real time during the online meeting and after the online meeting as a summary report.

19. A computer device for capturing and analyzing communication patterns by dynamically generating and analyzing metadata for online meetings, the computer device comprising at least one processor in communication with at least one memory device, wherein the at least one memory device stores computer-implemented instructions that cause the at least one processor to:
receive an audio stream of an online meeting, wherein the audio stream includes a plurality of participants on a team participating in the online meeting;
extract a plurality of metadata from the audio stream;
perform diarization on the audio stream and the plurality of metadata the audio stream to generate diarization information, wherein the diarization information includes information about participation for the plurality of participants on the team in the online meeting;
analyze the diarization information to detect communication and team patterns;
calculate one or more team performance key performance indicators (KPIs) based on the detected communication and team patterns;
generate recommendations for the team based on the detected communication and team patterns; and
generate visualization of the one or more team performance KPIs and the recommendations.

20. A computer-implemented method for capturing and analyzing communication patterns by dynamically generating and analyzing metadata for online meetings, the method implemented on a computer device including at least one processor in communication with at least one memory device, wherein the computer-implemented method comprises:
receiving an audio stream of an online meeting, wherein the audio stream includes a plurality of participants on a team participating in the online meeting;
extracting a plurality of metadata from the audio stream;
performing diarization on the audio stream and the plurality of metadata the audio stream to generate diarization information, wherein the diarization information includes information about participation for the plurality of participants on the team in the online meeting;
analyzing the diarization information to detect communication and team patterns;
calculating one or more team performance key performance indicators (KPIs) based on the detected communication and team patterns;
generating recommendations for the team based on the detected communication and team patterns; and
generating visualization of the one or more team performance KPIs and the recommendations.
